(19) United States
(12) Patent Application Publication
(10) Pub. No.: US 2005/0047117 A1
(43) Pub. Date: Mar. 3, 2005

(54) Head mounted face guard and light source

(76) Inventors: Susan R. Scholl, Toledo, OH (US); Patrick C. Scholl, Lavina, MT (US)

Correspondence Address: FRASER MARTIN BUCHANAN MILLER LLC, 132C WEST SECOND STREET, PERRYSBURG, OH, 43551-1401, US

(21) Appl. No.: 10/924,497

(22) Filed: Aug. 24, 2004

Related U.S. Application Data
(60) Provisional application No. 60/498,144, filed on Aug. 27, 2003.

(51) Int. Cl. F21V 21/084

(52) U.S. Cl. 362/106

(57) ABSTRACT

A face shield and light source assembly is disclosed wherein a light source is mounted to be pivotally movable independently of a face shield.

### CROSS REFERENCE TO RELATED APPLICATIONS

This application claims the benefit of U.S. Provisional Patent Application Ser. No. 60/498,144 filed Aug. 27, 2003.

### BACKGROUND OF THE INVENTION

1. Field of the Invention

The invention relates to a face shield and light source mounted on a head supported headband and more specifically to a light source mounted to be pivotally movable independently of the face shield.

2. Description of the Prior Art

Light sources carried by a head-mounted support are illustrated, for example, in U.S. Pat. No. 3,830,230 Chester; U.S. Pat. No. 4,530,112 Cecala et al.; U.S. Pat. No. 4,794,496 Lanes et al.; U.S. Pat. No. 5,667,292 Sabalvaro, Jr.; and U.S. Pat. No. 5,676,449 Newsome.

However, the light sources noted above were useful for the purposes for which they were designed, but fell short of satisfying some of the requirements for light sources necessary in the medical field and particularly in the field of dentistry.

It is a primary objective of the invention to produce a light source pivotally mounted on a visor with a source of power wherein the assembly is pivotally attached to an associated headband.

### SUMMARY OF THE INVENTION

The above objective, as well as others, may be achieved by a head mounted visor; a light source; a bracket assembly mounting the light source to the visor; a headband having a depending optically transparent face guard; means pivotally mounting the visor to the headband; a source of electric power mounted on the head band; and electrical conductor means providing electrical communication between the source of electric power and the light source.

### BRIEF DESCRIPTION OF THE DRAWINGS

The above objects and advantages of the invention will become readily apparent to those skilled in the art from reading the following detailed description of a preferred embodiment of the invention when considered in the light of the accompanying drawings, in which:

FIG. 1 is a top plan view of a head mounted visor and light source incorporating the novel features of the invention; and

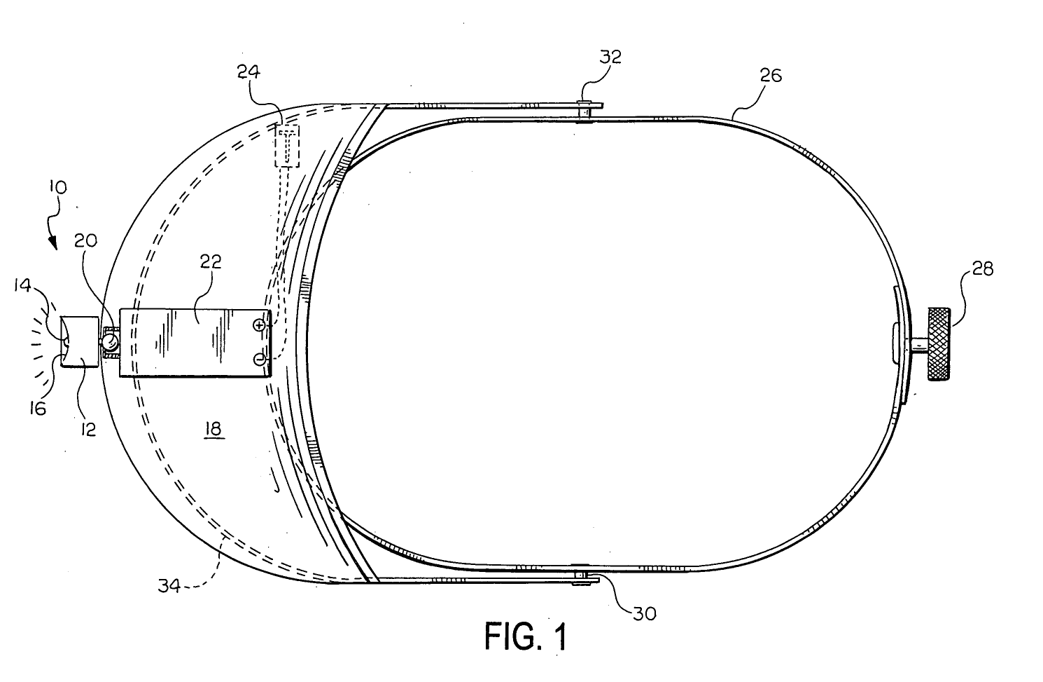

FIG. 2 is a side elevational view of the structure illustrated in FIG. 1.

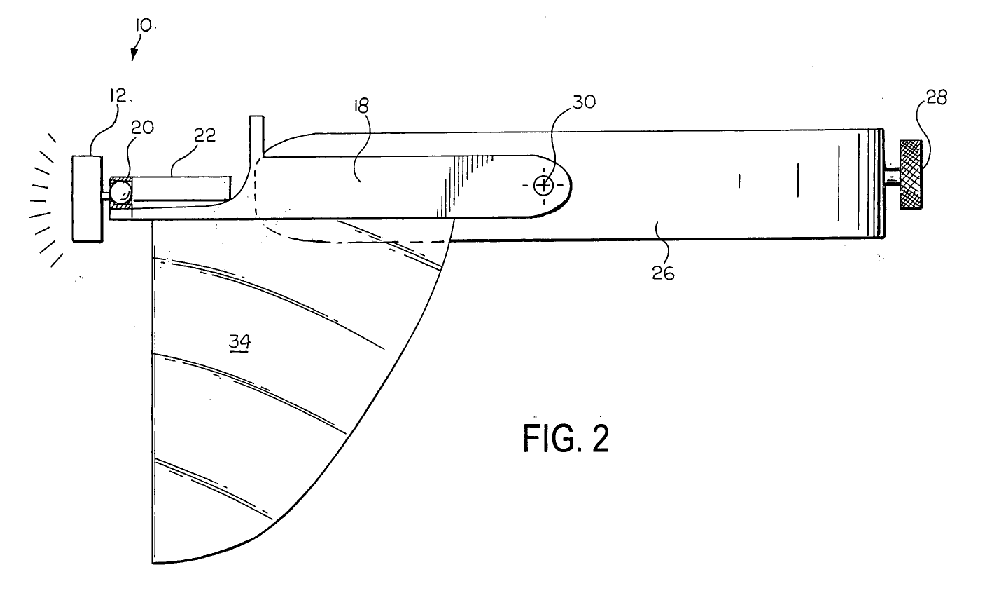

### DETAILED DESCRIPTION OF THE PREFERRED EMBODIMENT

Referring to the drawings, there is illustrated a light source assembly incorporating the features of the present invention. More specifically, there is illustrated a light source 10 having a main housing 12 encompassing an electric light bulb 14 and an associated reflector 16. The light source 10 is pivotally mounted to a visor 18 by a ball and socket bracket assembly 20. A source of electric energy 22, such as batteries, for example, is mounted to the upper portion of the visor 18 and is electrically connected to the electric light bulb 14. A switch 24, mounted to the visor 18, is provided to effectively control the energization of the light bulb 14 through associated conductors which electrically couple the source of electric energy 22 to the bulb 14.

A headband 26, provided with an adjusting screw 28, is adjustable to fit a user's head. The band 26 is preferably formed of a flexible plastic material.

The visor 18 and its associated light source 10 are pivotally coupled to the headband 26 by a pair of spaced apart pivotal couplings 30, 32.

An optically transparent face shield 34 is affixed to the visor 18 in any of a number of techniques such as by the application of a suitable adhesive, for example.

The light bulb 14 employed may be any of the conventional lamp bulbs and preferably may be the so-called halogen or krypton bulb which produces high intensity illumination.

It will be appreciated that a primary object of the invention involves the incorporation of a light source with a medical face shield and an associated visor wherein the light source may be energized by rechargeable batteries mounted on the top of the visor. The light source 10, which includes a light bulb 14 and an associated reflector 16, is mounted in a housing 12 pivotally attached to the visor 18 by a ball and socket swivel 20 to facilitate movement of the light source 10 relative to the visor 18 to achieve the desired movement and positioning of the light beam produced by the light bulb 14 and the reflector 16.

The visor 18, in turn, is pivotally attached to the adjustable headband 26 which stabilizes the light source 10 and will accommodate the weight of the light source 10 and associated batteries.

The particular type of light bulb 14 and battery will be determined by the preferred intensity, lamp life, and weight of the battery selected.

The combination of structural features has surprisingly resulted in a head mounted visor 18, face shield 34 and light source 10 for medical use in particular wherein the light source 10 may be readily adjusted relative to the visor 18 and the face shield 34. The visor 18 and face shield 34 may be pivoted to an inward position while allowing the light source 10 to be independently adjusted to a new direction of use or non-use.

In accordance with the provisions of the patent statutes, the present invention has been described in what is considered to represent its preferred embodiment. However, it should be understood that the invention can be practiced otherwise than as specifically illustrated and described without departing from its spirit or scope.

1. A head mounted face shield and light source, including:
a head band;
an optically transparent face shield attached to said headband;
a visor;
means pivotally mounting said visor to said headband;
a light source; and
a bracket pivotally mounting said light source to said visor, whereby said visor and said light source are pivotally movable in respect of said head band.

2. A head mounted face shield and light source as defined in claim 1 wherein said headband is adjustable.

3. A head mounted face shield and light source as defined in claim 1 wherein said face shield is caused to depend from said visor.

4. A head mounted face shield and light source as defined in claim 1 wherein said light source includes an electric light bulb and a reflector for reflecting light-produced by said light bulb.

5. A head mounted face shield and light source as defined in claim 4 further including a battery for energizing said light source.

6. A head mounted face shield and light source as defined in claim 5 further including means for interrupting the energization of said light source by said battery.

7. A head mounted face shield and light source as defined in claim 6 wherein said means for interrupting includes a switch.

8. A head mounted face shield and light source as defined in claim 7 wherein said battery and said switch are mounted on said visor.
